(19) United States
(12) Patent Application Publication
(10) Pub. No.: US 2009/0172643 A1
(43) Pub. Date: Jul. 2, 2009

(54) PROGRAM VERIFICATION APPARATUS, PROGRAM VERIFICATION METHOD, AND PROGRAM STORAGE MEDIUM

(75) Inventors: Kohei Maruchi, Tokyo (JP); Yoshio Kataoka, Kawasaki-Shi (JP); Masahiro Sakai, Kamakura-Shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/343,051

(22) Filed: Dec. 23, 2008

(30) Foreign Application Priority Data
Dec. 25, 2007 (JP) 2007-332152

(51) Int. Cl. G06F 9/44

(52) U.S. Cl. 717/126; 717/127

(57) ABSTRACT

A program verification apparatus includes: a program executing unit executing a program; a variable monitoring unit monitoring a plurality of variables in the program to obtain monitor values of the variables; a target variable determiner determining one or more target variables out of the variables; a constraint condition storage storing a first constraint condition that defines a constraint to be satisfied for each of the target variables and a second constraint condition that defines a constraint to be satisfied among the target variables; a state acquiring unit sequentially acquiring target program state each of which is a combination of monitor values of the target variables at same time respectively; a state generating unit generating an unreached target program state which has not been acquired yet and satisfies the first and second constraint conditions; and a state setting unit setting the unreached target program state to the program.

### CROSS REFERENCE TO RELATED APPLICATIONS

This application is based upon and claims the benefit of priority from the prior Japanese Patent Applications No. 2007-332152, filed on Dec. 25, 2007; the entire contents of which are incorporated herein by reference.

### BACKGROUND OF THE INVENTION

1. Field of the Invention

The present invention relates to a program verification apparatus, a program verification method, and a program storage medium storing a verification program for performing dynamic verification of a program.

2. Related Art

Dynamic verification of software (a program) is sometimes performed using a driver which is a high-level module of the software and a stub (a program) which is a low-level module of the software. In such a case, the driver issues commands as test cases and the software is run using the issued commands as input to the software.

A range in which software has been verified is called test coverage and the wider the test coverage runs, the higher reliability can be guaranteed for the software.

Test coverage includes code coverage that shows how many of statements in software have been covered, condition coverage that shows how many of true-false combinations in decision conditions in software have been covered, and path coverage that shows how many of execution paths in software have been covered. There is also state coverage which regards combinations of variable values in software as software states and shows how many of the software states have been covered. The state coverage involves finer classification than other test coverages. For instance, for path coverage, the number of possible paths is the number of classifications, whereas for state coverage, multiple combinations of variables exist for each path. Thus, state coverage requires a large number of classifications and expansion of state coverage often results in expansion of other test coverages. Hereinafter, reference to test coverage will refer to state coverage. To expand test coverage, it is necessary to thoroughly check the operation of software which is to be verified and execute a large number of test cases of various types.

However, conventional methods suffer from a problem of redundant tests tending to take place. As the number of tests grows, software is more likely to stay at operations in an already verified area and it becomes more difficult to expand test coverage. To expand test coverage, it is required to efficiently create a test case that reaches an unverified area of software. In general, however, it is difficult to generate a test case that will reach an intended area and a redundant test is inevitably repeated.

JP-A 2000-20349 (Kokai) describes that the internal state of software and that of a stub are stored during execution of target software and information on those states is used to reproduce the operation as of storage, thereby enabling reduction of redundant tests. To expand test coverage, however, it is necessary to use a test case that reaches an unverified area of software. However, JP-A 2000-20349 (Kokai) provides no reference to a method for generating such a test case.

### SUMMARY OF THE INVENTION

According to an aspect of the present invention, there is provided with a program verification apparatus, comprising:

a program executing unit configured to execute a program to be verified;

a variable monitoring unit configured to monitor a plurality of variables in the program to obtain monitor values of the variables;

a target variable determiner configured to determine one or more target variables out of the variables;

a constraint condition storage configured to store a first constraint condition that defines a constraint to be satisfied for each of the target variables and a second constraint condition that defines a constraint to be satisfied among the target variables;

a state acquiring unit configured to sequentially acquire target program states each of which is a combination of monitor values of the target variables at same time respectively;

a state generating unit configured to generate an unreached target program state which has not been acquired by the state acquiring unit yet and which satisfies the first and second constraint conditions; and

a state setting unit configured to set the unreached target program state to the program.

According to an aspect of the present invention, there is provided with a program verification method performed in an apparatus including a computer readable storage medium containing a set of instructions to make a computer processor to execute, the method comprising:

executing a program to be verified;

monitoring a plurality of variables in the program to obtain monitor values of the variables;

determining one or more target variables out of the variables;

reading a first constraint condition that defines a constraint to be satisfied for each of the target variables and a second constraint condition that defines a constraint to be satisfied among the target variables from a storage storing the first and second constraint conditions;

sequentially acquiring target program states each of which is a combination of monitor values of the target variables at same time respectively;

generating an unreached target program state which has not been acquired yet and satisfies the first and second constraint conditions; and

setting the unreached target program state to the program.

According to an aspect of the present invention, there is provided with a program storage medium storing a program for inducing a computer to execute instructions to perform the steps of:

executing a program to be verified;

monitoring a plurality of variables in the program to obtain monitor values of the variables;

determining one or more target variables out of the variables;

reading a first constraint condition that defines a constraint to be satisfied for each of the target variables and a second constraint condition that defines a constraint to be satisfied among the target variables from a storage storing the first and second constraint conditions;

sequentially acquiring target program states each of which is a combination of monitor values of the target variables at same time respectively;

generating an unreached target program state which has not been acquired yet and satisfies the first and second constraint conditions; and

setting the unreached target program state to the program.

### BRIEF DESCRIPTION OF THE DRAWINGS

FIG. 1 is a block diagram generally showing the configuration of a software verification system (a program verification apparatus) as an embodiment of the present invention;

FIG. 2 shows a range of conditional expressions in three-dimensional space;

FIG. 3 illustrates state transition of a stub;

FIG. 4 shows a correspondence table between variables and possible stub states;

FIG. 5 is a flowchart illustrating the procedure of processing in a software verification method (a program verification method) according to an embodiment of the present invention;

FIG. 6 is a flowchart illustrating a detailed flow of processing for acquiring an unreached condition;

FIG. 7 is a flowchart illustrating a detailed flow of processing for acquiring a constraint condition; and

FIG. 8 is a flowchart illustrating a detailed flow of processing for acquiring an invariant condition.

### DETAILED DESCRIPTION OF THE INVENTION

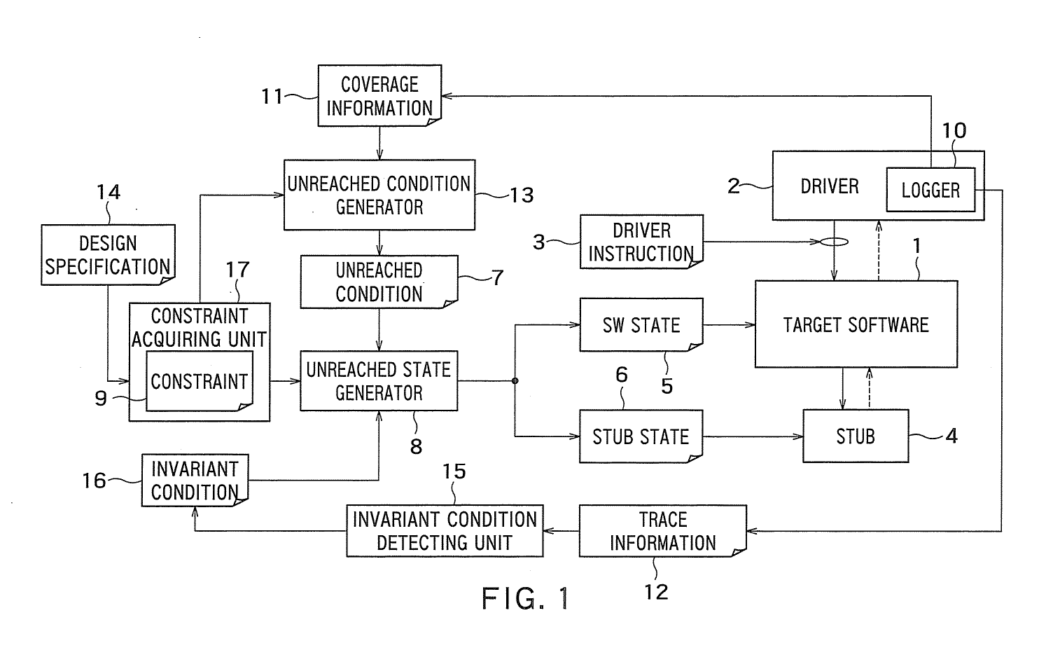

FIG. 1 is a block diagram generally showing the configuration of a software verification system (a program verification apparatus) as an embodiment of the present invention. The system (apparatus) may include a computer readable storage medium (program storage medium) containing a set of instructions to make a computer processor to execute.

Target software 1 is software (a program) that is subjected to dynamic verification. The target software 1 may be some of multiple modules contained in certain software or one of multiple modules deployed in a certain system. Dynamic verification refers to verification that makes the target software 1 actually operate and checks if it behaves normally. Operation of the target software 1 generally requires modules called a driver and a stub and this embodiment also employs a driver 2 and a stub 4. However, the present invention is also effective in verification of software that does not use a driver and a stub. The driver 2 and a stub 4 correspond to a program executing unit, for example.

The driver 2 is a high-level module for running the target software 1. The driver 2 causes the target software 1 to operate by issuing a driver instruction 3. The driver instruction 3 is a command sequence that can be executed by the target software 1 or a command that directly calls a subroutine in the target software 1.

The stub 4 is a low-level module (a program) that is operated by the target software 1. The stub 4 is called by the target software 1 and performs processing as appropriate for a call. When the target software 1 is software inside a system, the stub 4 may be a simulator that simulates hardware or mechanics.

A logger 10 collects log information for all variables (i.e. monitor values of all variables) in the target software 1 and the stub 4 before and after the driver 2 issues the driver instruction 3 to the target software 1. The logger 10 includes a variable monitoring unit for monitoring a plurality of variables. The log information includes coverage information 11 and trace information 12, both of which include information on SW (software) states and stub states that have been reached during operation of the target software 1. The SW and stub states are sometimes called program states.

The SW state is any of combinations of values of all variables at same time in the target software 1 (i.e., combinations of variable values referenced at same time by the target software 1). The stub state is any of combinations of values of all variables at same time in the stub (i.e., combinations of variable values referenced at same time by the stub 4). The variables of the target software 1 and those of the stub 4 may be either local or global variables. In addition, while combinations of values of all variables in the target software 1 are defined as the SW state and combinations of values of all variables in the stub 4 as the stub state here, combinations of values of variables that are predesignated in the target software 1 may be defined as the SW state and combinations of values of variables predesignated in the stub 4 may be defined as the stub state. In that case, the logger 10 may collect log information only for variables that are predesignated in the target software 1 and the stub 4.

The coverage information 11 is used by an unreached condition generator 13 discussed below and the trace information 12 is used by an invariant condition detecting unit (or condition generating unit) 15 described below. The coverage information 11 and the trace information 12 each include contents specific to intended use and may be the same or different information.

For the logger 10 to acquire log information (coverage information 11 and trace information 12), the logger 10 has to be able to access variables in the target software 1 and the stub 4. This can be realized by writing the logger 10 as a routine in the driver 2 and re-defining variables of the target software 1 and the stub 4 from local variables to global variables, for example. Alternatively, the logger 10 may directly access memory in a computer system on which the target software 1 and the stub 4 operate, thereby acquiring variable values. In the latter case, the logger 10 can directly access variables by making reference to mapping information that maintains memory addresses at which individual variables are assigned.

Design specification 14 is information regarding the specification and detailed design of the target software 1 and the stub 4. The design specification 14 includes at least information about constraints for each variables, constraints among variables, and the like. Constraint information for a variable may be information on the lower and upper limits of the variable value, for instance. In this case, the lower and upper limit values may be described directly in the design specification 14 or may be determined from the type of a variable if variable type is described. Information on constraints among variables may be information on the lower and upper limit values of a function expression that contains multiple variables, for example.

A constraint condition acquiring unit 17 has a constraint condition input unit for the user to enter a constraint condition for each variable or among variables. Specifically, there is, as the constraint condition, a first constraint condition that defines a constraint to be satisfied for each variable and a second constraint condition that defines a constraint to be satisfied among the variables. In the following, the first and second constraint conditions are collectively called simply. The user inputs a constraint condition from the constraint condition input unit, and the constraint condition acquiring unit 17 stores the constraint condition input by the user. The constraint condition acquiring unit 17 has a constraint condition storage unit for storing constraint conditions entered by the user. The constraint condition acquiring unit 17 sends a stored constraint condition to where it will be used (the unreached condition generator 13 and unreached state generator 8). The generators 8 and 13 use constraint conditions of different contents, which will be described in greater detail below.

The user can decide a constraint condition by referencing constraint information described in the design specification 14, for example, and input the constraint condition. For instance, when the design specification 14 describes that the target software 1 maintains a table having a maximum of 20 entries and stores an entry ID it references in “entry_id”, the user can decides a relational expression, 0≦“entry_id”<20, and input the expression as a constraint condition. A constraint can exist between a variable of the target software 1 and a variable of the stub 4, wherein the user can also decide and input a relational expression.

Although it is described here that the constraint condition acquiring unit 17 acquires a constraint condition based on user input, computer-readable design specification may be prepared and the constraint condition acquiring unit 17 may read the design specification to acquire a constraint condition for each variable or among variables.

The unreached condition generator 13 receives a constraint condition 9 relating to a target variable (i.e., a variable that should be verified at the present time among all variables included in the coverage information 11) from the constraint condition acquiring unit 17. The unreached condition generator 13 includes a target variable determiner which determines one or more target variables out of the variables. The number of target variables is single or multiple. The unreached condition generator 13 receives the constraint condition 9 for each target variable and the constraint condition 9 among target variables. Based on the constraint condition 9 it received and the coverage information 11, the unreached condition generator 13 generates a condition for the target variable that has not been reached by the target software 1 (an unreached SW variable condition) and a condition for the target variable that has not been reached by the stub 4 (an unreached stub variable condition) as the unreached condition 7. The unreached condition generator 13 outputs the generated unreached conditions 7 to the unreached state generator 8.

The unreached SW variable condition represents an area that has not been reached yet in the entire area of the target program state which is represented by a combination of values of target variables in the target software 1, and the unreached stub variable condition represents an area that has not been reached yet in the entire area of the target program state which is represented by a combination of values of target variables in the stub 4.

The unreached condition generator 13 includes a state acquiring unit for sequentially acquiring the target program state in the target software 1 and the stub 4 based on the coverage information 11 received from the logger 10.

When there is no more unreached area for the target variable (i.e., when verification is completed), the unreached condition generator 13 may select another target variable and again request the acquisition of a constraint condition 9 and generate an unreached condition 7.

In the following, several examples of generation of the unreached condition 7 will be provided.

As a first example, the unreached condition 7 can be generated by utilizing the constraint condition 9 that includes the minimum and maximum values of variables (the target variables) for which lower and upper limits are set. During dynamic verification, change in the value of the target variables which is indicated in the coverage information 11 is checked and only the minimum and maximum values are stored, and a target variable whose lower and upper limit values have not been reached is found. Then, the unreached condition 7 is generated for a target variable at least whose upper or lower limit value has not been reached. More specifically, the range between the lower and upper limits excluding the range between the minimum and the maximum values is generated as the unreached condition 7, for example. For example, when the minimum and maximum values of a target variable “x” is 3 and 15 respectively (3≦x≦15), and the lower and upper limit values are 0 and 20, respectively, the unreached condition 7 will be 0≦x≦2v16≦x≦20, where “x” is an integer and “v” means “OR”.

As a second example, the unreached condition 7 can be generated using a function expression that contains one or more target variables and for which lower and upper limit values are set as the constraint condition 9. Based on the coverage information 11, the values of the function expression are calculated and only the minimum and maximum values of the function value are stored. Then, the unreached condition 7 is generated for a function expression for which at least either of the upper or lower limit value for the function has not been reached. Specifically, the range between the lower and upper limit values of the function excluding the range between the minimum and the maximum value is generated as the unreached condition 7. For example, for a function expression 2x+y, when its minimum and maximum values are 6 and 15, respectively (6≦2x+y≦15), and the lower and upper limit values of the function are 0 and 100, respectively, the unreached condition 7 will be 0≦2x+y≦5 v 16≦2x+y≦100.

As a third example, the unreached condition 7 can be generated using a conditional expression that includes a target variable as the constraint condition 9. Based on the coverage information 11, it is determined whether a conditional expression has held or not. As the conditional expression, one that can assume both true and false is desirably selected from the design specification 14. It is also possible to use a condition for a decision statement written in the target software 1 as the conditional expression, in which case a conditional expression could be automatically extracted by a computer such as the constraint condition acquiring unit 17 using a static analysis technique. The unreached condition generator 13 looks for a conditional expression that satisfies only either true or false and acquires a condition that corresponds to the unsatisfied value as the unreached condition 7. For instance, if a conditional expression x+y<20 is has already held, 20≦x+y is acquired as the unreached condition 7, where “x” and “y” are the target variables.

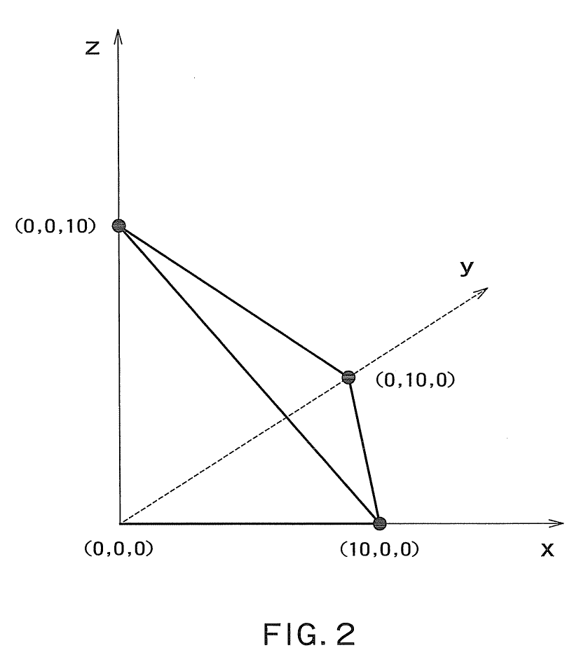

Selection of the conditional expression in the third example may also be based on information on a constraint among the target variables that is obtained from the design specification 14. As an example, assume that for target variable “x”, “y” and “z”, constraint information “x+y+z≦10” is described in the design specification 14 and the target variables x, y and z are non-negative. A three-dimensional representation of the range of values that can be assumed by the three target variables “x”, “y” and “z” in this case is shown in FIG. 2. Coordinates (0, 0, 0), (10, 0, 0), (0, 10, 0), and (0, 0, 10) are the vertices of the shape of the range, and x+y≦10̂z=0, x+z≦10̂y=0, y+z≦10̂x=0, and x+y+z=10 represent the boundary planes of the shape. Then, a conditional expression that determines whether each of the vertices and boundary planes has been reached or not is used as the constraint condition 9. For example, a conditional expression for determining whether the vertex (0, 0, 10) has been reached or not is x=0̂y=0̂z=10, and one for determining whether a boundary place x+y+z=10 has been reached or not is x+y+z=10. Then, if any of such conditional expressions is not met, that conditional expression is acquired as the unreached condition 7. In such a manner, it is possible to define a range that can be assumed by n number of target variables in an n-dimensional space from constraint information among those target variables, select a conditional expression that determines whether a boundary point (i.e., a vertex or boundary plane) has been reached or not as a constraint condition, and obtain a conditional expression that has not held yet as the unreached condition 7.

The invariant condition detecting unit (condition generating unit) 15 makes reference to the trace information 12 generated by the logger 10 to detect a condition that holds among variables of the software 1, among variables of stub 4, and between variables of the two as an invariant condition (first condition) 16. The invariant condition 16 is an inter-variable conditional expression that always holds in the trace information 12, and is used for generating likely SW state 5 and stub state 6 in the unreached condition generator 8, which is discussed below. Being likely means that it satisfies a condition that always holds in the trace information 12. The invariant condition detecting unit 15 sends detected conditional expressions to the unreached state generator 8 excluding ones that include target variables only (not exclude a conditional expression that includes both the target variables and other variable different from the target variables). For detection of the invariant condition 16, Daikon developed by M. Ernst's research group at Massachusetts Institute of Technology (http://groups.csail.mit.edu/pag/daikon/) can be used.

Daikon is a tool for checking the transition of variable values during software operation and finding conditions and constraints that hold among variables by means of machine learning. Constraints and conditions that can be obtained are invariant information that holds among variables, e.g., information such as x=y+3 or that “array ‘a’ is sorted in ascending order”. Execution time required by Daikon depends on the size of the trace information 12 and especially strongly on the number of variables for which log is kept. Since it is not practical to keep log for all variables relating to the target software 1 and the stub 4 in most cases, it is preferable to limit the number of variables for which log is kept as the trace information 12. For instance, the total number of variables for which log is kept may be predetermined. When the number of variables is limited in such a way, the invariant condition 16 can be efficiently extracted by appropriately deciding variables for which log is kept.

An example of the way of determining the variables for which log is kept as the trace information 12 is provided. First, log information is obtained by performing short-time dynamic verification for acquiring log for all variables, and invariant conditions (second conditions) are acquired from the obtained log information by means of Daikon. Because the dynamic verification is performed in a short time, the size of log information (trace information 12) is small even through log for all variables is kept and Daikon can be run in a short amount of time. However, since the invariant conditions (the second conditions) thus obtained result from dynamic verification of a short time, they are likely to be conditions or constraints that hold by chance and are low in reliability. By analyzing the invariant conditions thus obtained, variables that occur with a high frequency are detected, only the detected variables are decided as variables for which log should be kept, and only the decided variables are used to generate an invariant condition (the first condition or third condition). By deciding variables for which log is kept in such a way, it is possible to extract the invariant condition 16 more efficiently than when simply selecting variables arbitrarily.

As another way of deciding variables for which log is kept, it is also possible to analyze invariant conditions, find an invariant condition (or a relational expression) that occurs with a high frequency, and set a polynomial contained in the relational expression that has been found as the target of log keeping. For instance, when a polynomial x+y+z frequency occurs, two variables for which log is kept can be eliminated by keeping log for the polynomial x+y+z instead keeping log for the variables “x”, “y” and “z”.

The unreached state generator (state generating unit, state setting unit) 8 calculates the SW state 5 and stub state 6 (that is, overall program state) that contain values of all variables so that the constraint condition 9, unreached condition 7 and invariant condition 16 are met, and sets the calculated SW state 5 and the stub state 6 for the target software 1 and the stub 4. However, as other variables than the target variables are not contained in the unreached condition 7, arbitrary values may be set for the constraint condition 9 and the invariant condition 16 so as to meet the conditions. Here, the constraint condition 9 used by the unreached state generator 8 contains expressions (conditions) that have other variables than the target variables. This is because the unreached state generator 8 needs to assign values also to variables other than the target variables. Although such expressions or conditions may contain target variables, in which case it is assumed that other variables than the target variables are also contained and expressions that are made up only of target variables are not contained. This is because an expression (condition) that is made up only of target variables is used solely for generating the unreached condition 7.

A problem of thus selecting values from a finite set of discrete values corresponding to all variables and assigning values to all the variables so that all constraints are met is called a constraint satisfaction problem. One of well-known solutions of the constraint satisfaction problem is backtracking method. The backtracking method first selects variables and assign values to them. At the time of assignment, it is checked whether all constraints relating to only variables to which assignment is already done are satisfied. It the constraints are satisfied, a variable to which assignment has not been done is selected and assignment is continued until values are assigned to all the variables. If the constraints are not satisfied, a value for assignment is changed. If there is no assignment value that meets the constraints, already performed assignment to a variable which relates to the constraint that cannot be satisfied is canceled and assignment is performed again.

It is described above that information on constraints between a variable of the target software 1 and one of the stub 4 may be included in the design specification 14. A specific example of this and an example of a corresponding constraint condition will be described below in detail.

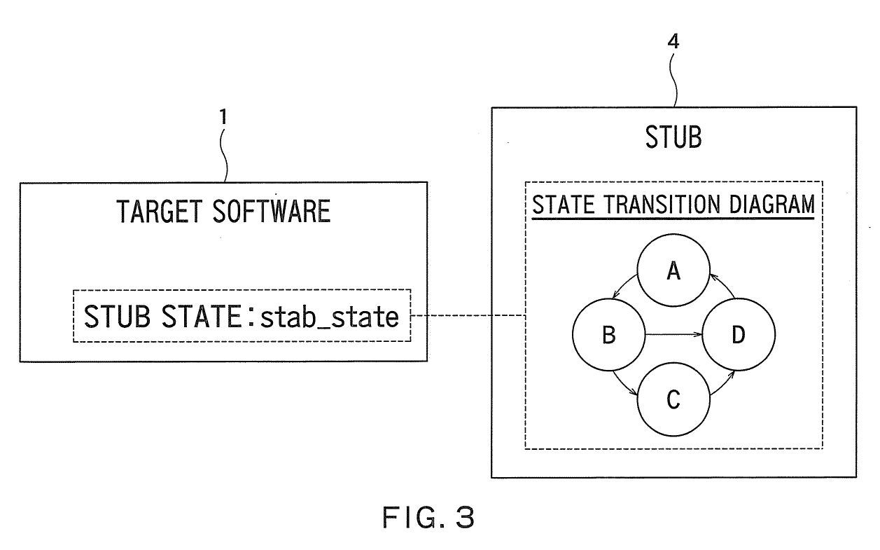

For instance, consider a case where the target software 1 maintains the state of the stub 4 in a variable “stub_state”, as shown in the left side of FIG. 3. The right side of FIG. 3 shows the state transition diagram of the stub 4. When the target software 1 is used as control software in an embedded system, the stub 4 functions as a simulator for mechanics/hardware that is to be controlled. It is a common practice for control software to maintain the state of a mechanics (the state of the stub 4) in a variable.

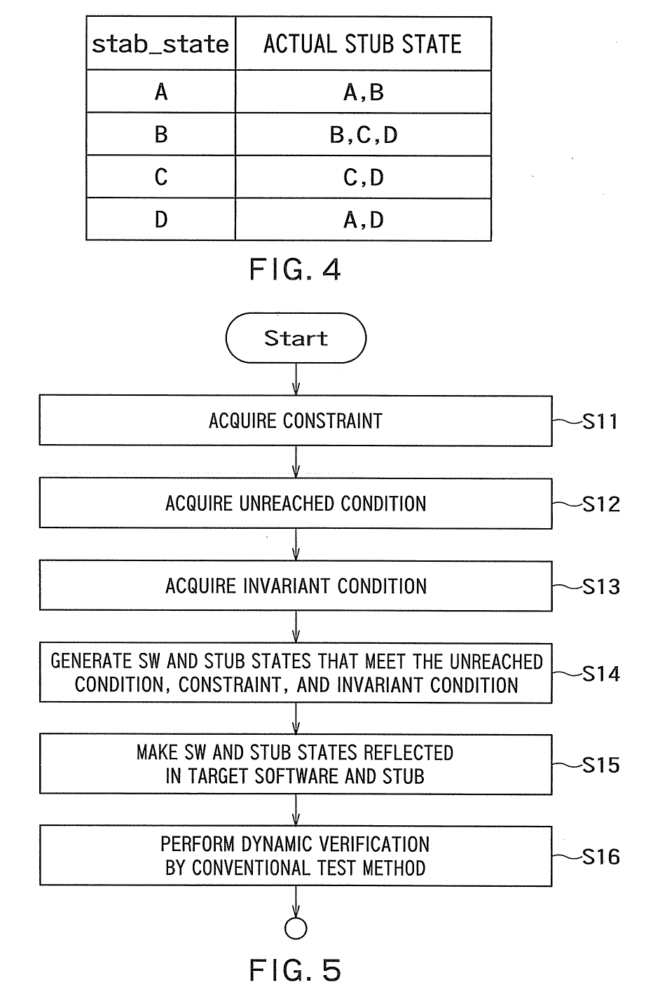

Assume that the design specification 14 requires that stub_state be updated when there has been a state transition in response to an order from the control software and the termination of the state transition has been recognized. In this case, assuming that the value of variable stub_state is “A”, the stub state can be either A or has already transitioned to “B”. Since transition to state “C” or “D” requires the control software to be aware that the variable stub_state is in state “B”, it is impossible that variable stub_state transitions to state “C” or “D” while remaining in state “A”. FIG. 4 shows a table on correspondence between the variable stub_state and possible stub states.

Even if the control software could be operated with a combination that violates the table of FIG. 4 (e.g., variable stub_state=A and stub state=C), the operation is in an out-of-spec state and correct verification of operation cannot be performed. To avoid such a situation, a lapse into an out-of-spec state is prevented by using an appropriate condition as the constraint condition 9. Assume that the stub state is defined according to the value of variable “sb1” as follows:

State A: 0≦sb1<5

State B: 5≦sb1<10

State C: 10≦sb1<20

State D: 20≦sb1

In this case, following constraint conditions can be extracted based on the table of FIG. 4:

A constraint condition: if stub_state==A, 0≦sb1<10

A constraint condition: if stub_state==B, 5≦sb1

A constraint condition: if stub_state==C, 10≦sb1

A constraint condition: if stub_state==D, 0≦sb1<5 or 20≦sb1

By the way, when determining the SW state 5 and stub state 6, there are often an enormous number of ranges that can be assumed by these states.

By way of example, consider a case in which variables “vtl”, “vt2”, and “vt3” are integers and the ranges that can be assumed by the respective variables are 0≦vt1≦2, 1≦vt2≦3, and 0≦vt3≦1. In this case, as the SW state that can be assumed by the target software 1 is any of combinations of (vt1, vt2, vt3), there will be 18 combinations in total: (0, 1, 0) (0, 1, 1) (0, 2, 0) (0, 2, 1) (0, 3, 0) (0, 3, 1) . . . (1, 3, 0) and (1, 3, 1). Also, when a variable “vf” is a 4-byte-long floating-point type variable, “vf” can assume 2³² possible values, thus the number of SW states that can be assumed by the target software 1 is also 2³².

We will provide below an example of a method for efficiently generating a state in such circumstances by utilizing boundary analysis based on equivalence partitioning and expanding the processing by the logger 10 and the unreached condition generator 13.

For instance, consider a case where variable “vd” of the target software 1 is the target variable. Initially, conditional expressions to which the variable “vd” relates are obtained. The conditional expressions may be found from the design specification 14 or source code and supplied to the logger 10 and the unreached condition generator 13 by the user or may be obtained by the logger 10 scanning source code. If conditional expressions obtained are vd<5, 23<vd, and vd<100, equivalence sets can be derived as follows.

Equivalence set A: variable vd that meets vd<5

Equivalence set B: variable vd that meets 5≦vd≦23

Equivalence set C: variable vd that meets 23<vd<100

Equivalence set D: variable vd that meets 100≦vd

Thus, when the value of variable “vd” is equivalence-partitioned into four sets, the four sets, i.e., “A”, “B”, “C”, and “D”, can be considered as the values that can be assumed by “vd”.

The logger 10 generates as the coverage information 11 information that shows whether an equivalence set has been reached. For instance, information that “variable ‘vd’ has already reached equivalence sets ‘A’, ‘C’, and ‘D’” may be included in the coverage information 11 generated, for example.

The unreached condition generator 13 checks the coverage information 11 received from the logger 10 and detects any equivalence set that has not been reached. In the present example, the unreached condition generator 13 finds that variable “vd” has not reached equivalence set “B” from the coverage information 11. The unreached condition generator 13 generates the unreached condition 7 based on the equivalence set “B” detected. Specifically, the unreached condition generator 13 adopts a boundary value of variable “vd” as the unreached condition 7. This is for applying the boundary analysis method and in consideration of a property of a fault being likely to hide at the boundaries of an equivalence set. By deciding the value of the target variable in this way, efficient state generation becomes possible. Since the boundary values of equivalence set “B” are 5 and 23, the unreached condition 7 may be vd=5, for example. However, it is assumed that the constraint condition 9 sent from the constraint condition acquiring unit 17 to the unreached condition generator 13 is met. If the unreached state generator 8 is able to generate the SW state 5 or the stub state 6 so that the unreached condition 7 (vd=5) is met, verification for variable “vd” is completed. On the other hand, if the unreached state generator 8 is not able to do so, it adopts another boundary value of equivalence set “B” if any, as the unreached condition 7. Since the equivalence set B has another boundary value of 23, the unreached state generator 8 adopts the value as the unreached condition 7 and attempts to generate the SW state 5 or stub state 6 again. If it cannot generate the SW state 5 or stub state 6 after attempting all boundary values, the unreached state generator 8 generates the condition for the equivalence set “B” as the unreached condition 7. That is to say, 5≦vd≦23 is used as the unreached condition 7.

While the above description shows an example of a conditional expression that includes only variable “vd”, other target variable than variable “vd” may be contained. For instance, if a conditional expression determined contains other target variable “vd”, like vd≦5, vd1<vd, such equivalence sets as follows can be derived:

Equivalence set A′: variable “vd” that meets vd≦5̂vd1<vd

Equivalence set B′: variable “vd” that meets 5<vd̂vd1<vd

Equivalence set C′: variable “vd” that meets vd≦5̂vd1≧vd

Equivalence set D′: variable “vd” that meets 5<vd̂vd1≧vd

FIG. 5 is a flowchart illustrating the procedure of processing by a software verification method (a program verification method) according to an embodiment of the present invention.

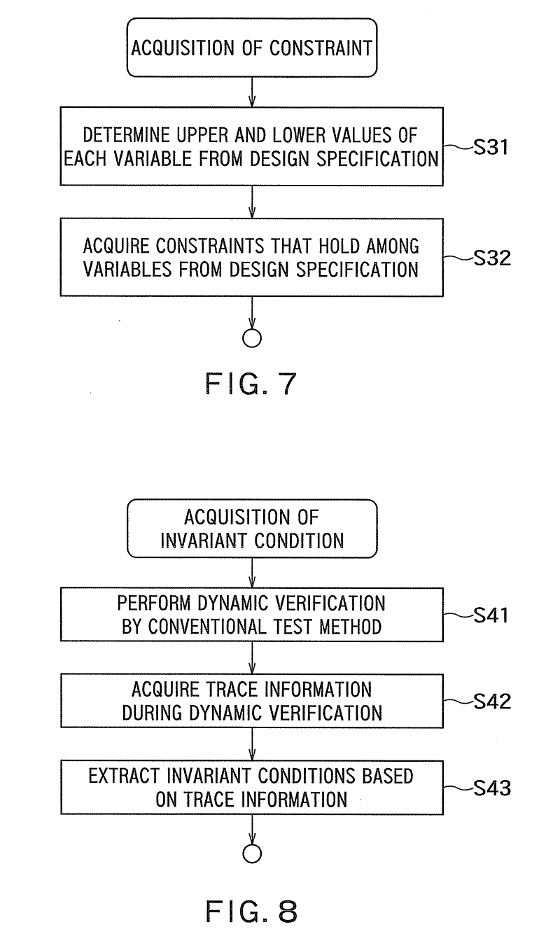

First, at step S11, the constrain 9 is obtained by the constraint condition acquiring unit 17. An example of a detailed process flow for acquiring the constraint condition 9 is shown in the flowchart of FIG. 7. The upper and lower limit values of all variables are determined (S31), and conditions that hold among variables are enumerated (S32). What are obtained at S31 and S32 serve as the constraint condition 9. The constraint condition 9 may be obtained based on used input or by reading from the design specification 14.

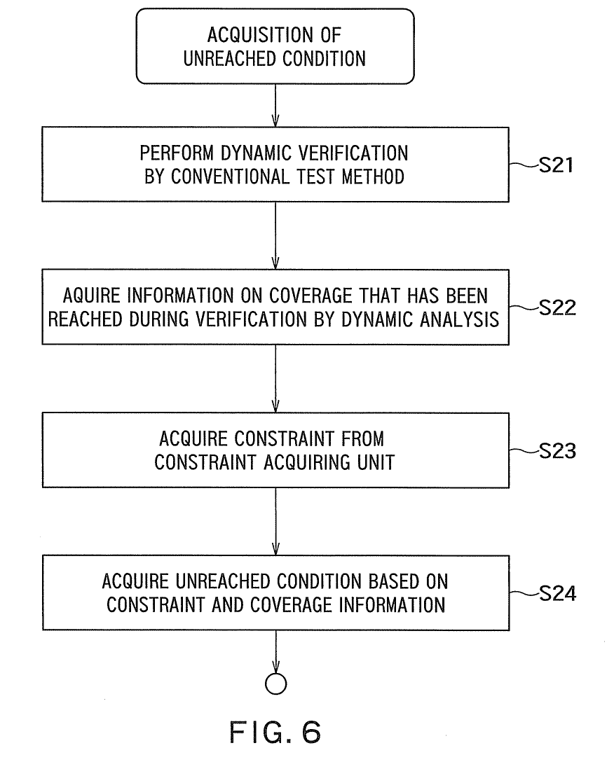

At step S12 of FIG. 5, the unreached condition 7 is obtained by the unreached condition generator 13. A detailed process flow for acquiring the unreached condition 7 is shown as the flowchart of FIG. 6. First, the target software 1, driver 2, and stub 4 are run and the driver instruction 3 from the driver 2 is used to perform dynamic verification by a conventional test method (S21). This process may be the same dynamic verification as that performed at S16 in FIG. 5 or S41 in FIG. 8, which will be discussed later. During the dynamic verification, the coverage information 11 is acquired and accumulated from the logger 10 (S22), and the constraint condition 9 relating to the target variable is obtained from the constraint condition acquiring unit 17 (S23). Then, based on the constraint condition 9 obtained at step S23 and the coverage information 11 (coverage information so far accumulated), the unreached condition 7 is obtained (S24).

At step S13 in FIG. 5, the invariant condition detecting unit 15 determines the invariant condition 16. By using the invariant condition 16, it is possible to take into consideration conditions that cannot be extracted from the design specification 14 or implicit conditions that cannot be found from the design specification 14, which can improve the reliability of verification. The invariant condition 16 can be obtained according to the procedure of the flowchart shown in FIG. 8. First, conventional dynamic verification is performed (S41). As mentioned above, this process may be the same dynamic verification as S16 and S21. During this dynamic verification, the trace information 12 is obtained from the logger 10 (S42). Then, based on the obtained trace information 12, the invariant condition 16 is extracted (S43).

At step S14 of FIG. 5, the unreached state generator 8 generates the SW state 5 and stub state 6 so that the unreached condition 7, constraint condition 9, and invariant condition 16 are met.

At step S15 of FIG. 5, the SW state 5 and stub state 6 generated are made reflected in the target software 1 and the stub 4. Since the SW state 5 and the stub state 6 are each a set of variable values, values may be assigned to all the variables to make the SW state 5 and the stub state 6 reflected. Values may be assigned to the variables by making and using a software routine for assigning values to the variables or utilizing a map of memory addresses at which the variables are allocated to write values directly into the memory.

At step S16 of FIG. 5, conventional dynamic verification is performed again. Because the processing at step S15 causes the target software 1 to start operation from an unreached SW state 5 and an unreached stub state 6, test coverage can be expanded reliably and efficiently.

Processing in the flows shown in the flowcharts from FIGS. 5 to 8 may be realized by creating a verification program which describes instruction codes for executing the processing with a conventional programming technique and causing the verification program to be executed by a computer such as a CPU. The verification program may also be stored in a computer-readable storage medium and read out and executed by a computer.

As has been described above, according to the embodiment of the present invention, a SW state and a stub state that have not been reached yet are obtained during dynamic verification of the target software 1 and the stub 4, and dynamic verification is performed starting from the SW and stub states obtained. It is thereby possible to efficiently expand test coverage and reduce software development cost and time.

What is claimed is:

1. A program verification apparatus, comprising:
a program executing unit configured to execute a program to be verified;
a variable monitoring unit configured to monitor a plurality of variables in the program to obtain monitor values of the variables;
a target variable determiner configured to determine one or more target variables out of the variables;
a constraint condition storage configured to store a first constraint condition that defines a constraint to be satisfied for each of the target variables and a second constraint condition that defines a constraint to be satisfied among the target variables;
a state acquiring unit configured to sequentially acquire target program states each of which is a combination of monitor values of the target variables at same time respectively;
a state generating unit configured to generate an unreached target program state which has not been acquired by the state acquiring unit yet and which satisfies the first and second constraint conditions; and
a state setting unit configured to set the unreached target program state to the program.

2. The apparatus according to claim 1, wherein
the first constraint condition includes a range of values taken by a first target variable which is one of the one or more target variables,
the state acquiring unit specifies minimum and maximum monitor values of the first target variable from among the monitor values of the first target variable, and
the state generating unit generates the unreached target program state which is a value of the first target variable included within the range taken by the first target variable excluding a range between specified minimum and maximum monitor values.

3. The apparatus according to claim 1, wherein
the second constraint condition includes a range of operation values taken by an operation expression defined by using the target variables,
the state acquiring unit calculates the operation expression based on each target program state and specifies minimum and maximum operation values of the operation expression, and
the state generating unit generates the unreached target program state which is a combination of values of the target variables where an operation value of the operation expression is included within the range of the operation values taken by the operation expression excluding a range between specified minimum and maximum operation values.

4. The apparatus according to claim 1, wherein
the second constraint condition includes a conditional expression defined by the target variables,
the state acquiring unit determines whether the conditional expression is true or false based on each target program state, and
the state generating unit generates the unreached target program state which is a combination of values of the target variables at which the conditional expression become true if true for the conditional expression has not held yet, or at which the conditional expression become false if false for the conditional expression has not held yet.

5. The apparatus according to claim 1, further comprising
a condition generating unit configured to generate a first condition that holds among the variables based on monitor values of the variables, wherein
the state acquiring unit sequentially acquires overall program states each of which is a combination of monitor values of the variables at same time respectively;
the state generating unit generates an unreached overall program state which have not been acquired yet and which satisfies the first condition and the first and second constraint conditions; and
the state setting unit sets the unreached overall program state to the program.

6. The apparatus according to claim 1, wherein
the constraint condition generating unit
generates second conditions that hold among the variables based on the monitor values of the variables,
detects variables included with a high frequency in the second conditions, and
generates a third condition that holds among the detected variables based on the monitor values of the detected variables,
the state acquiring unit sequentially acquires overall program states each of which is a combination of monitor values of the variables at same time respectively,
the state generating unit generates an unreached overall program state which have not been acquired yet and which satisfies the third condition and the first and second constraint conditions, and
the state setting unit sets the unreached overall program state to the program.

7. A program verification method performed in an apparatus including a computer readable storage medium containing a set of instructions to make a computer processor to execute, the method comprising:
executing a program to be verified;
monitoring a plurality of variables in the program to obtain monitor values of the variables;
determining one or more target variables out of the variables;
reading a first constraint condition that defines a constraint to be satisfied for each of the target variables and a second constraint condition that defines a constraint to be satisfied among the target variables from a storage storing the first and second constraint conditions;
sequentially acquiring target program states each of which is a combination of monitor values of the target variables at same time respectively;
generating an unreached target program state which has not been acquired yet and satisfies the first and second constraint conditions; and
setting the unreached target program state to the program.

8. A program storage medium storing a program for inducing a computer to execute instructions to perform the steps of:
executing a program to be verified;
monitoring a plurality of variables in the program to obtain monitor values of the variables;
determining one or more target variables out of the variables;
reading a first constraint condition that defines a constraint to be satisfied for each of the target variables and a second constraint condition that defines a constraint to be satisfied among the target variables from a storage storing the first and second constraint conditions;
sequentially acquiring target program states each of which is a combination of monitor values of the target variables at same time respectively;
generating an unreached target program state which has not been acquired yet and satisfies the first and second constraint conditions; and
setting the unreached target program state to the program.
